(19) United States
(12) Patent Application Publication
(10) Pub. No.: US 2025/0026901 A1
(43) Pub. Date: Jan. 23, 2025

(54) METHOD OF MAKING A CROSSLINKED SILICONE FOAM, CROSSLINKED SILICONE FOAMS PREPARABLE THEREBY, AND ADHESIVE ARTICLE INCLUDING THE SAME

(71) Applicant: 3M INNOVATIVE PROPERTIES COMPANY, St. Paul, MN (US)

(72) Inventors: Junkang J. Liu, Woodbury, MN (US); Pingfan Wu, Woodbury, MN (US); Jeffrey P. Kalish, St. Paul, MN (US); Lianzhou Chen, Woodbury, MN (US)

(21) Appl. No.: 18/710,275

(22) PCT Filed: Nov. 23, 2022
(86) PCT No.: PCT/IB2022/061353

§ 371 Date: May 15, 2024

Related U.S. Application Data
(60) Provisional application No. 63/284,280, filed on Nov. 30, 2021.

(51) Int. Cl. C08J 9/00; C08J 3/28; C09J 5/08; C09J 7/38; C09J 183/10

(52) U.S. Cl. CPC C08J 9/0061; C08J 3/28; C09J 5/08; C09J 7/387; C09J 183/10; C08J 2201/026; C08J 2205/04; C08J 2207/02; C08J 2383/10; C08J 2483/04; C09J 2301/302; C09J 2301/416; C09J 2483/00

(57) ABSTRACT

Crosslinked silicone foams can be prepared from first and second poly(organosiloxane)s using electron beam radiation. The first poly(organosiloxane) has Si—H groups and the second poly(organosiloxane) has Si—OH groups. Adhesive articles including pressure-sensitive adhesive crosslinked silicone foams are also disclosed.

### TECHNICAL FIELD

The present disclosure broadly relates to crosslinked silicone foams and methods of making and using them using electron beam radiation.

### BACKGROUND

Silicone foams are synthetic rubber products often used in gasketing. and cushions. Constituent components of silicone foam are mixed together, they evolve hydrogen gas, which causes bubbles to form within the rubber, as it changes from liquid to solid. This results in an outward pressure. Temperature and humidity can influence the rate of expansion.

Pressure-sensitive adhesives (PSAs) are an important class of materials. Silicone PSAs offer one or more of the following useful characteristics: adhesion to low surface energy (LSE) surfaces, quick adhesion with short dwell times, wide use temperature (i.e., performance at high and low temperature extremes), weathering resistance (including resistance to ultraviolet (UV) radiation, oxidation, and humidity), reduced sensitivity to stress variations (e.g., mode, frequency and angle of applied stresses), and resistance to chemicals (e.g., solvents and plasticizers) and biological substances (e.g., mold and fungi).

Silicone PSAs are commonly formed by a condensation reaction between a polymer or gum and a tackifying resin. The polymer or gum is typically a high molecular weight silanol-terminated poly(organosiloxane) material such as, for example, silanol-terminated poly(dimethylsiloxane) or poly(methylphenylsiloxane). The tackifying resin is typically a three-dimensional silicate structure end-capped with trimethylsiloxy groups. In addition to the terminal silanol groups of the polymer or gum, the tackifying resin may also include residual silanol functionality.

Silicone pressure-sensitive adhesives and foams containing hollow microspheres have also been formed from various silicone precursors using electron beam radiation (also commonly termed “e-beam”) as described in U.S. Pat. No. 9,359,529 (Liu et al.).

### SUMMARY

Methods according to the present disclosure are suitable for preparing crosslinked silicone foams. Crosslinked silicone foams may be useful, for example, as adhesives (e.g., pressure-sensitive adhesive foams), gaskets, and/or cushioning materials, especially for the applications requiring wide temperature windows, extreme weathering stability, and/or good flame retardancy.

Pressure-sensitive adhesives are well known to those of ordinary skill in the art to possess certain properties at room temperature (e.g., 20-25 degrees Celsius (C)) including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure-sensitive adhesives are polymers designed and formulated to exhibit the requisite viscoelastic properties resulting in a desired balance of tack, peel adhesion, and shear strength.

Polymeric foams are known to trap pockets of gas in solid polymer networks. Due to the presence of cellular structures, polymer foams are generally lightweight and compressible with excellent thermal and acoustic insulation efficacies.

Self-adherent foams possess a combination properties of both foams and adhesives, which often provide synergistic properties. such as unique peel mechanics, dissipating more peeling energies from foam deformation.

Silicone foams are often used as gaskets, gap fillers, and thermal/acoustic barriers due to their superior elastic resilience, thermal resistance, and flame retardancy. Silicone foam sheets are difficult to make because both blowing and curing processes are thermal processes in the traditional silicone foam manufacturing via either catalyzed addition or condensation reaction, and it is often difficult to balance between rapid cure speed where fast reaction is preferred for high productivity and extended pot life where slow or no reaction is preferred to prevent premature gelation.

Advantageously, silicone foams prepared according to the present disclosure may be formed more efficiently than prior methods due to the presence of SiH and SiOH groups in the silicone foam precursor materials which react with high energy radiation to form hydrogen and an Si—O—Si linkage in the absence of any curing catalysts, and which provides fast curing and virtually unlimited pot life.

In one aspect, the present disclosure provides a method of making a crosslinked silicone foam, the method comprising:
disposing a crosslinkable composition on a first substrate, wherein the crosslinkable composition comprises components:
   (i) at least one first poly(organosiloxane) having a plurality of Si—H groups, and
   (ii) at least one second poly(organosiloxane) having a plurality of Si—OH groups; and
exposing the crosslinkable composition to high energy radiation in an amount effective to form a crosslinked poly(organosiloxane) foam disposed on the first substrate.

In another aspect, the present disclosure provides a crosslinked poly(organosiloxane) foam preparable by the method of the present disclosure.

In yet another aspect, the present disclosure provides a crosslinked poly(organosiloxane) foam comprising Si—H groups and Si—OH groups, wherein the crosslinked poly(organosiloxane) foam is free of an effective amount of organic peroxide and free and of effective amount of dehydrogenative coupling catalyst for the reaction of the Si—H groups with the Si—OH groups.

In yet another aspect, the present disclosure provides a crosslinked poly(organosiloxane) foam adhesive comprising MQ silicone tackifying resins.

As used herein, the term “poly(organosiloxane)” refers to a molecule (often an oligomer or polymer) having a plurality of repeating groups represented by the general formula

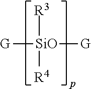

wherein: each R³ independently represents alkyl or aryl; each R⁴ independently represents alkyl, aryl, or H; p is an integer greater than or equal to 2; and each G independently represents a terminal residue consisting of C, H, and optionally O.

As used herein, the term “high energy radiation” refers to electron beam (i.e., e-beam) radiation and gamma radiation (i.e., electromagnetic radiation having a photon energy of ≥100 kiloelectron volts) produced by radioactive decay.

Features and advantages of the present disclosure will be further understood upon consideration of the detailed description as well as the appended claims.

### BRIEF DESCRIPTION OF THE DRAWINGS

FIG. 1 is a schematic side view of an adhesive article 100 according to the present disclosure. It should be understood that numerous other modifications and embodiments can be devised by those skilled in the art, which fall within the scope and spirit of the principles of the disclosure. The figures may not be drawn to scale.

### DETAILED DESCRIPTION

To make a crosslinked poly(organosiloxane) foam according to the present disclosure, a crosslinkable composition is typically disposed on a first substrate.

Suitable substrates may include any solid substrate such as, for example, polymer films; polymer foams, woven or nonwoven fabrics, meshes, or nets, metal foils, glasses, glass fibers, papers, laminates, ceramics, ceramic papers, composites, and treated and/or primed versions thereof, and combinations thereof. In some embodiments, the substrate can be an endless belt. The first substrate may have any desired form including, for example, a tape, a sheet, a gasket, or a printed circuit (e.g., a flex circuit or a printed circuit board).

If the crosslinked poly(organosiloxane) foam comprises at least a portion of a silicone PSA, it is common for the first substrate to comprise a releasable liner. For example, the first substrate may comprise a polymer film containing a release additive such as a fluorosilicone or other fluorinated additive that is blended with the polymer and co-extruded during manufacture resulting a polymer film with a low surface energy that can function as a releasable liner for a silicone PSA. In other embodiments, a low surface energy coating (e.g., or a fluorosilicone or other fluorinated material) on the substrate may be useful as a releasable liner for use with a silicone PSA.

The crosslinked poly(organosiloxane) foam may be formed by high energy irradiation of a crosslinkable composition comprising at least one first poly(organosiloxane) having a plurality of Si—H groups and at least one second poly(organosiloxane) having a plurality of Si—OH groups.

in Exemplary suitable first poly(organosiloxane)s having a plurality of Si—H groups can be represented by the formula

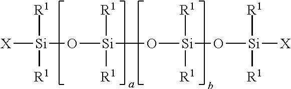

Each R¹ independently represents an alkyl group having from 1 to 18 carbon atoms or phenyl. Examples of suitable alkyl groups include methyl, ethyl, propyl, butyl, pentyl, hexyl, heptyl, octyl, decyl, dodecyl, hexadecyl, and octadecyl. Methyl and ethyl are often preferred. In some embodiments. each R¹ independently represents an alkyl group having from 1 to 8 carbon atoms, or an alkyl group having from 1 to 4 carbon atoms, or phenyl.

Each X independently represents hydrogen (i.e., H) or R¹ wherein R¹ is as previously defined.

The subscript a represents an integer greater than or equal to zero (in some embodiments at least 1, at least 2, at least 5, at least 10, at least 20, at least 30, or even at least 40). If only one X is H then a is at least one, and if neither X is H then a is at least two. In some embodiments, a is zero. In this case, both X groups represent H. Typically, a is less than 100 (e.g., less than 50) although this is not a requirement.

The subscript b represents an integer greater than or equal to two (in some embodiments at least 5, at least 10, at least 20, at least 30, or even at least 40). Typically, b is less than 100 (e.g., less than 50) although this is not a requirement.

Examples of suitable first poly(organosiloxane)s include trimethylsilyl-terminated methylhydrosiloxane-dimethylsiloxane copolymers marketed, for example, by: Gelest Inc., Morrisville, Pennsylvania (e.g., product codes: HMS-013, HMS-031, HMS-053, HMS-064, HMS-071, HMS-082,HMS-151, HMS-301*, HMS-501, HMS-993); SiSiB Silanes and Silicones, Nanjing, China (e.g., under the trade designations SISIB HF2050 in grades 100H75, 15H75, 55H55, 22H55, 60H36, 15H36, 15H100, 60H120, 15H43, 115H41, 21H20, 70H18, 20H11, and HF2050); and Dow Corning, Midland, Michigan (e.g., under the trade designation SYL-OFF 7678).

Examples of suitable first poly (organosiloxane) s also include: trimethylsilyl-terminated poly (methylhydrosiloxane), for example. as marketed by Genesee Polymers Corp., Burton, Michigan. under the trade designations GP-499, GP-535, GP-536, and GP-678 and from SiSiB Silanes and Silicones, Hanjing, China under the trade designation PF2020; trimethylsilyl-terminated poly (ethylhydrosiloxane), for example, as marketed by SiSiB Silanes and Silicones under the trade designation HF2025; hydrogen-terminated polydimethylsiloxane as marketed by SiSiB Silanes and Silicones under the trade designation HF2030 in grades M134, M400, M1250, M200, M400, M7500, M10000, M17500, M28000, and M62000; hydrogen terminated-polydiphenylsiloxane, for example, as marketed by SiSiB Silanes and Silicones under the trade designation HF2038; hydride-terminated methylhydrosiloxane dimethylsiloxane copolymer, for example, as marketed by SiSiB Silanes and Silicones under the trade designation HF2060; hydride-terminated phenylhydrosiloxane dimethylsiloxane copolymer, for example, as marketed by SiSiB Silanes and Silicones under the trade designation HF2068; and hydride-terminated poly (methylphenylsiloxane), for example, as marketed by SiSiB Silanes and Silicones under the trade designation HF2080.

In some embodiments, the first poly (organosiloxane) s has/have a number average molecular weight (Mₙ) of 400 to 100000 grams/mole, often 500 to 50000 grams/mole or even 600 to 10000 grams/mole, although higher and lower molecular weights may also be used.

Each one of the at least one second poly(organosiloxane) has a plurality of Si—OH groups. In some embodiments, suitable second poly(organosiloxane)s are represented by the formula

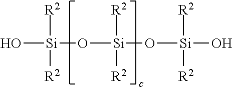

Each R² independently represents an alkyl group having from 1 to 18 carbon atoms or phenyl. Examples of suitable alkyl groups include methyl, ethyl, propyl, butyl, pentyl, hexyl, heptyl, octyl, decyl, dodecyl, hexadecyl, and octadecyl. Methyl and ethyl are often preferred. In some embodiments, each R¹ independently represents an alkyl group having from 1 to 8 carbon atoms, or an alkyl group having from 1 to 4 carbon atoms, or phenyl.

The subscript c represents an integer greater than or equal to two (in some embodiments at least 5, at least 10, at least 20, at least 30, or even at least 40). Typically, c is less than 100 (e.g., less than 50) although this is not a requirement.

Examples of suitable second poly(organosiloxane)s include hydroxy-terminated poly(dimethylsiloxane)s marketed. for example, by Gelest under the product numbers of DMS-S31,DMS-S32, DMS-S35, DMS-S42, DMS-S45, and DMS-S51; by Dow Corning under the trade designation OHX4070; by Genesee Polymer Corp. under the trade designation GP-426; by MilliporeSigma, Saint Louis, Missouri, under the product numbers 481939, 481955, 432997, 432989, 481963, 482005, 482161; and from SiSiB Silanes and Silicones under the trade designation OF0025.

The first and second poly(organosiloxane)s can be generally made according to conventional methods and/or obtained from commercial suppliers. Commercial suppliers of suitable poly(organosiloxane)s include, for example, SiSiB Silanes and Silicones; Genesee Polymers Corp.; Wacker Chemie AG, Munich, Germany; Dow Corning, Midland, Michigan; Momentive Performance Materials, Waterford, New York; Solvay, Brussels, Belgium; MilliporeSigma; and Shin-Etsu Chemical Co., Tokyo, Japan.

The first and second poly(organosiloxane)s are combined into a crosslinkable composition that may comprise additional components. Examples of such components may include one or more filler(s) (e.g., hollow glass microspheres or expandable polymeric microspheres), tackifier(s), rheology modifier(s), colorant(s), organic solvent(s), surfactant(s), or a combination thereof. The crosslinkable composition is normally mixed using a high speed mixing device or is compounded continuously using a twin screw extruder, although this is not a requirement.

If formulating adhesive compositions, and especially silicone PSAs, a silicone tackifying resin is typically included in the crosslinkable composition, although this is not a requirement.

Generally, any known tackifying resin may be used. For example, in some embodiments silicone tackifying resins may be used. In some exemplary adhesive compositions, a plurality of silicone tackifying resins can be used to achieve a level of desired performance.

Suitable silicone tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), Q (i.e., quaternary SiO_{4/2} units), and combinations thereof. R′ represents a lower alkyl group, often methyl or ethyl, and most often methyl. Typical exemplary silicone tackifying resins include MQ silicone tackifying resins, MQD silicone tackifying resins, and MQT silicone tackifying resins. These silicone tackifying resins usually have a number average molecular weight in the range of 100 to 50,000 grams/mole, e.g., 500 to 15,000 g/mol.

MQ silicone tackifying resins are copolymeric resins where each M unit is bonded to a Q unit, and each Q unit is bonded to at least one other Q unit. Some of the Q units are bonded to only other Q units. However, some Q units are bonded to hydroxyl groups resulting in HOSiO_{3/2} units (i.e., T^{OH} units), thereby accounting for some silicon-bonded hydroxyl content of the silicone tackifying resin.

MQ silicone tackifying resins may have at least one structural subunit represented by the formula

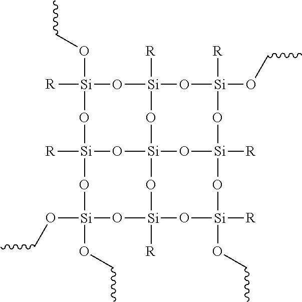

wherein each R independently represents CH₃, vinyl, H, or OH, and wherein [symbol] , indicates additional molecular structure.

The level of silicon bonded hydroxyl groups (i.e., silanol) on the MQ silicone tackifying resin may be reduced to no greater than 1.5 weight percent, no greater than 1.2 weight percent, no greater than 1.0 weight percent, or no greater than 0.8 weight percent based on the weight of the silicone tackifying resin. This may be accomplished, for example, by reacting hexamethyldisilazane with the silicone tackifying resin. Such a reaction may be catalyzed, for example, with trifluoroacetic acid. Alternatively, trimethylchlorosilane or trimethylsilylacetamide may be reacted with the silicone tackifying resin, a catalyst not being necessary in this case.

MQD silicone tackifying resins are terpolymers having M, Q, and D units. In some embodiments, some of the methyl R′ groups of the D units can be replaced with vinyl (CH₂═CH—) groups (“D” units). MQT silicone tackifying resins are terpolymers having M. Q and T units.

Suitable silicone tackifying resins are commercially available from sources such as Dow Corning (e.g., DC2-7066) and Momentive Performance Materials (e.g., 5R545 and SR1000).

Silicone foams typically provide properties including, for example, resilience, wide service temperature stability (e.g., −50° C. to about 200° C.), inertness, and inherent flame retardancy forming char without flame dripping. Generally, silicone foams have been made in processes where cell growth or expansion (i.e., the foaming process) and cell stabilization (i.e., the crosslinking process) are happened simultaneously. Many common cell expansion chemistries for silicone foams rely on thermally activated chemical blowing agents (e.g., azo-containing compounds) or condensed gas by-product from thermal crosslinking reactions (e.g., hydrogen gas). In contrast, by using a high energy radiation process. cell expansion (foaming process) and cell stabilization (crosslinking) can be conducted at room temperature and optimized independently from compounding and/or mixing steps which can be conducted at elevated temperature. This may reduce the formulation viscosity for better mixing (e.g., hot melt mixing by twin screw extruder), accelerate curing, and create sufficient hydrogen gas by-product to form cellular structure in the crosslinked silicone network. Although hot melt compounded e-beam curable silicone chemistries were described in U.S. Pat. No. 9,359,529 (Liu et al.) the hydrogen gas by-product by dehydrogenation from methyl groups and coupling to each other were not sufficient enough to form cellular structures in crosslinked silicone networks in the disclosed chemistries. It is now unexpectedly discovered that using crosslinkable compositions comprising both silanol and silicone hydride functionality according to the present disclosure provides significantly faster and/or more extensive foaming can be achieved using high energy radiation to cure silicone formulations containing both silicon hydride (Si—H) and silanol (Si—OH) groups. In many embodiments, this can lead to improved control over cell structures with uniform distribution of foam cell sizes.

Crosslinked silicone foams can optionally include hollow microspheres (e.g., glass bubbles and polymeric microspheres, including thermally expandable polymeric microspheres) in the crosslinkable composition, however it is typically unnecessary to include them and may even be detrimental to cost and/or the manufacturing process.

Glass bubbles are known in the art and can be obtained commercially and/or be made by the techniques known in the art. Useful glass bubbles include glass bubbles available from 3M Company, St. Paul, Minnesota under the trade designation 3M SCOTCHILITE GLASS BUBBLES (e.g., in grades K1, K15, S15, S22, S28HS, K20,K25, S32, S32HS, K37, 538H5, K46,A16/500, A20/1000, and D32/4500); glass bubbles available from Potters Industries, Malvern, Pennsylvania, under the trade designation Q-CELL HOLLOW SPHERES (e.g., in grades 30, 6014, 6019, 6028, 6036, 6042, 6048, 5019, 5023, and 5028); and glass bubbles available from Silbrico Corp., Hodgkins, Illinois, under the trade designation SIL-CELL (e.g., in grades SIL 35/34, SIL-32, SIL-42, and SIL-43). Those glass bubbles generally have an average density in a range of 0.1 g/cm³ to 0.5 g/cm³ and an average bubble size in a range of 5 to 250 micrometers.

Polymeric microspheres are hollow spheres with polymeric shells. In some embodiments, expandable polymeric microspheres could be used. Such expandable microspheres generally include a polymer shell and a core material in the form of a gas, liquid, or a combination (e.g., propane, butane, pentane, isobutene, neopentane, and combinations thereof). Upon heating, the shell softens and core expands, causing the shell to expand without breaking. Upon cooling, the shell re-hardens, and the expandable microsphere remains expanded. Exemplary thermally expandable polymeric microspheres have an acrylonitrile-containing shell and suitable core materials. Useful expandable microspheres include microspheres available from Henkel Corp., Plainfield, Illinois, under the trade designation MICROPEARL (e.g., in grades F30, F80, and F 100) and microspheres marketed by Akzo-Nobel under the trade designation EXPANCEL (e.g., as Expancel 551, Expancel 461, and Expancel 091).

In many embodiments, the crosslinkable composition and/or the crosslinked poly (organosiloxane) foam are free of hollow microspheres, however this is not a requirement.

Methods and crosslinkable compositions according to the present disclosure do not require the use of catalysts or initiators (e.g., dehydrogenative coupling catalysts for the reaction of the Si—H groups with the Si—OH groups or organic peroxides, which typically are thermally reactive). Thus, the methods of the present disclosure can be used to compound foamable and crosslinkable silicone formulations at elevated temperatures (e.g., as in melt extrusion) without concern of premature gelation and can be used to form crosslinked silicone compositions that are free of an effective amount of organic peroxides (effective amount is typically >0.2 weight percent) and/or free of an effective amount of dehydrogenative coupling catalysts for the reaction of the Si—H groups with the Si—OH groups (effective amount is typically >1 part per million by weight (ppm) for Pt and Rh catalysts and >0.2 weight percent for Sn and Ti catalysts). Exemplary dehydrogenative coupling catalysts for the reaction of the Si—H groups with the Si—OH groups include certain metal compounds (e.g., platinum-divinyltetramethyldisiloxane complex, rhodium-tris (dibutylsulfide) trichloride complex, tin-dibutyl diacetoxy, and titanium isopropoxide).

A variety of procedures for e-beam crosslinking/curing are well-known in the art. The degree of crosslinking generally depends on the specific equipment used to deliver the electron beam, and those of ordinary skill in the art can define a dose calibration model for the equipment used. Commercially available electron beam generating equipment is readily available. One example is an Electrocure 300 kv electron beam generating apparatus available from Energy Sciences, Inc., Wilmington, Massachusetts.

Gamma radiation emitting radionuclides are the most widely used gamma radiation sources. Exemplary radionuclides include the most useful are cobalt-60, caesium-137, technetium-99m and americium-241.

Often, during the curing process, a support film (e.g., polyester terephthalate film) runs through an inert chamber. In some embodiments, no separate support film is used and a substrate (e.g., a first substrate) that is a part of the manufactured article serves as a support film. In some embodiments, the crosslinkable composition with first and second substrates (e.g., a fluorosilicone release liner) on both sides (“closed face”), optionally attached to the support film. In some embodiments, the crosslinkable composition may be applied to a first substrate, with no second substrate on the opposite surface (i.e., and “open face” configuration). In either case, the crosslinkable composition may then be exposed to high energy radiation from one side through the release liner, for example.

For making crosslinked silicone foams, which are typically relatively thick, a single-side pass through the electron beam may result in an undesirable crosslinking gradient through the thickness of the tape so that it may be more suitable to expose the crosslinkable composition to electron beam radiation from both sides.

Single-pass and/or multiple-pass high energy radiation exposure may be carried out, for example, depending on the dose and conditions. Generally, however, there should be sufficient exposure of the crosslinkable composition to the high energy radiation to form a stable crosslinked silicone foam.

In some embodiments, foamable and curable silicone formulations may be coated between two substrates. Webs having such a sandwiched construction may be wound as a jumbo roll and further gamma irradiated (e.g., by exposure to a gamma radiation source) to form the crosslinked silicone foam between two substrates.

The crosslinked poly(organosiloxane) foam may be an open cell foam, a closed cell foam, or a combination of the two. In some embodiments, the crosslinked poly (organosiloxane) foam has a porosity of at least 10 volume percent, at least 20 volume percent, at least 30 volume percent, at least 40 volume percent, at least 50 volume percent, at least 60 volume percent, or even at least 70 volume percent, although this is not a requirement. The use of a sandwich configuration in which the crosslinkable composition is sandwiched between two films (e.g., releasable liners) generally increases porosity.

In many embodiments, the crosslinked poly(organosiloxane) foam is a pressure-sensitive adhesive at 20° C.

In some embodiments, the first and/or second substrate comprises a releasable liner and the crosslinked poly(organosiloxane) foam is sandwiched therebetween. In such embodiments, the crosslinked poly(organosiloxane) foam is often a pressure-sensitive adhesive at 20° C. For example, such construction may comprise a transfer sheet or transfer tape. In use, the first and second substrates are sequentially removed and the crosslinked poly(organosiloxane) foam is adhered to at least one adherence, often two on opposite sides of the crosslinked poly(organosiloxane) foam.

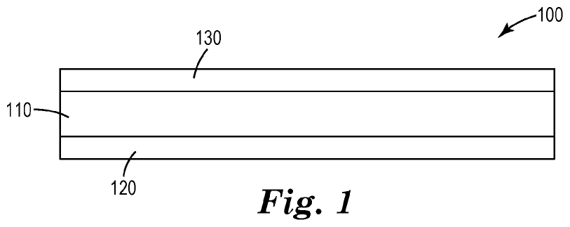

Referring now to FIG. 1, adhesive article 100 comprises a crosslinked poly(organosiloxane) foam 110 according to the present disclosure sandwiched between a first substrate 120 and a second substrate 130. First substrate 120 is releasably adhered to the crosslinked poly(organosiloxane) foam. In some embodiments, second substrate 130 is also releasably adhered to the crosslinked poly(organosiloxane) foam. In many embodiments, crosslinked poly(organosiloxane) foam 110 is a PSA at 20° C.

Examples of adhesive articles include tapes and sheets with PSA foam releasably adhered to the first substrate and various transfer PSA articles (e.g., tapes, sheets, or gaskets) if releasably adhered to the optional second substrate.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Table 1, below, reports materials used in the Examples.

TABLE 1

| ABBREVIATION | DESCRIPTION AND SOURCE |
|---|---|
| OHX4070 | Silanol terminated polydimethyl siloxane (60,000 cSt) from Dow |
| | Chemical, Midland, Michigan |
| TMS803 | Belsil TMS 803 MQ resin available from Wacker Chemie, Munich, |
| | Germany |
| HMS993 | HMS-993 polymethylhydrosiloxane from Gelest, Morrisville, |
| | Pennsylvania |
| DMS-T46 | DMS-T46 polydimethylsiloxane, trimethylsiloxy terminated (60,000 cSt) |
| | from Gelest |
| DMS-S42 | DMS-S42 silanol terminated polydimethylsiloxane (18000 cSt) from |
| | Gelest |
| DMS-S45 | DMS-S45 silanol terminated polydimethyl siloxane (50000 cSt) from |
| | Gelest |
| DMS-S51 | DMS-S51 silanol terminated polydimethyl siloxane (90000-150000 cSt) |
| | from Gelest |
| HP | Dragonite HP halloysite clay particles from Applied Minerals New York, |
| | New York |
| AP462 | Exolite AP462 ammonium polyphosphate from Clariant, Muttenz, |
| | Switzerland |
| E065 | Dualite E065-135D, acrylonitrile copolymer shell expanded |
| | microspheres, average particle size 130 microns, available from Chase |
| | Corporation, Westwood, Massachusetts |
| FR Cros 486 | FR Cros 486 polyphosphates from Budenheim, Mansfield, Ohio |
| K1 | 3M glass bubbles K1, 65 microns mean particle diameter, 3M Company, |
| | Maplewood, Minnesota |
| K15 | 3M glass bubbles K15, 60 microns mean particle diameter, 3M Company |
| S28HS | 3M glass bubbles S28HS, 30 microns mean particle diameter, 3M |
| | Company |
| S32HS | 3M glass bubbles S32HS, 25 microns mean particle diameter, 3M |
| | Company |
| L1 | Release liner, polyester film containing a perfluorinated melt additive |

### Foam Density Measurement

Foam density (D) was calculated in pounds per cubic foot (PCF). In the measurement, a die cut 4 in×6 in (10.2 cm×15.2 cm) specimen was measured by its thickness (L) in mils and weight (W) in grams and calculated by the following formula:

$$\\ D = 25400 \times 144 / 454 \times W / ( L \times 4 \times 6 )$$

### 180° Peel Adhesion Test

According to the procedure described in ASTM D 3330-90 (1990), peel adhesion strength was measured at 72° F. (22° C.) and 50% relative humidity (RH) using a IMASS peel tester (SP2100, IMASS Inc., Accord, Massachusetts). A tape test specimen measuring 1 inch (2.54 centimeters) wide by approximately 5 inches (13 centimeters) long was applied to a pre-cleaned, flat, rigid stainless steel (SS) substrate. The SS substrates was cleaned by wiping with isopropyl alcohol, followed by wiping with methyl ethyl ketone, and heptane with a clean lint free tissue, and then allowing them to air dry prior to use. To apply the tape specimen to the substrate, hand rolling 4.5 pounds (2.0 kg) hard rubber roller (no additional force necessary) at a rate of approximately 2 inches (50 millimeters)/second was used to ensure intimate contact with the substrate surface. The test specimen was tested immediately after preparation (Instant Peel). The free end of the tape test specimen was doubled back at an angle of 180° and attached to the load cell apparatus. The substrate was attached to the moveable platen on the instrument. The peel adhesion test was run at a constant rate of 12 inches (30.5 centimeters)/minute and the average peel adhesion force was recorded in gram/inch (g/cm).

### EXAMPLES 1-24 and COMPARATIVE EXAMPLE A

Ingredients in amounts as reported in Table 2 were combined in a plastic cup, covered with a cap, and mixed using a high shear mixer for 4 minutes. The mixtures were coated between two L1 liners through a knife coater with 30 mil (0.76 mm) gap. The resulting sandwiched coated sheets were then radiated with an electron beam from both sides at 300 kev and dose levels reported in Table 2. Table 3 reports physical properties of the Examples in Table 2. Film thickness was measured using optical or electron microscopy. In Table 3 “FT” indicates finger tacky.

TABLE 2

| | | | | | | | E-BEAM |
|---|---|---|---|---|---|---|---|
| | | | SILICONE | EXPANDED | GLASS | | DOSE, |
| EXAMPLE | POLYSILOXANE | MQ | HYDRIDE | MICROSPHERES | BUBBLES | ADDITIVE | Mrad |
| Comparative | 100 g DMS-T46 | | | | | | 12 |
| Example A | | | | | | | |
| 1 | 69 g OHX4070 | 31 g TMS803 | 2 g HMS993 | | | | 12 |
| 2 | 69 g OHX4070 | 31 g TMS803 | 5 g HMS993 | | | 20 g FR 486 | 15 |
| 3 | 69 g OHX4070 | 31 g TMS803 | 5 g HMS993 | 2 g E65 | | 50 g FR 486 | 15 |
| 4 | 69 g OHX4070 | 31 g TMS803 | 5 g HMS993 | 2 g E65 | 5 g K15 | 50 g FR 486 | 15 |
| 5 | 69 g OHX4070 | 31 g TMS803 | 5 g HMS993 | | 5 g K15 | 20 g FR 486 | 15 |
| 6 | 100 g S51 | 5 g TMS803 | 10 g HMS993 | | | | 15 |
| 7 | 100 g S45 | 5 g TMS803 | 10 g HMS993 | | | 50 g FR 486 | 15 |
| 8 | 100 g S45 | | 10 g HMS993 | | | 50 g HP | 15 |
| 9 | 100 g S51 | 5 g TMS803 | 10 g HMS993 | | | 50 g FR486 | 15 |
| 10 | 100 g S45 | 5 g TMS803 | 10 g HMS993 | | 5 g K15 | 50 g HP | 15 |
| 11 | 100 g S45 | 5 g TMS803 | 10 g HMS993 | | 5 g S28HS | 50 g HP | 15 |
| 12 | 100 g S45 | 5 g TMS803 | 10 g HMS993 | | 5 g S32HS | 50 g HP | 15 |
| 13 | 100 g S45 | | 10 g HMS993 | | | | 15 |
| 14 | 100 g S45 | 5 g TMS803 | 10 g HMS993 | | 5 g K15 | 50 g FR 486 | 15 |
| 15 | 100 g S42 | 5 g TMS803 | 10 g HMS993 | | | | 15 |
| 16 | 69 g OHX4070 | 31 g TMS803 | 2 g HMS993 | | | 20 g AP462 | 15 |
| 17 | 69 g OHX4070 | 31 g TMS803 | 2 g HMS993 | 2 g E65 | | 50 g AP462 | 15 |
| 18 | 200 g S51 | | 20 g HMS993 | | | 100 g HP | 15 |
| 19 | 200 g S51 | | 20 g HMS993 | | | 50 g HP + | 15 |
| | | | | | | 50 g AP462 | |
| 20 | 200 g S51 | 5 g TMS803 | 20 g HMS993 | | | | 15 |
| 21 | 200 g S51 | 5 g TMS803 | 20 g HMS993 | | | 100 g HP | 15 |
| 22 | 200 g S51 | 2 g TMS803 | 20 g HMS993 | | 2 g of K1 | 100 g HP | 15 |
| 23 | 200 g S45 | 5 g TMS803 | 20 g HMS993 | | | | 15 |
| 24 | 200 g S42 | 5 g TMS803 | 20 g HMS993 | | | | 15 |

TABLE 3

| | | SHEET | SHEET | PEEL | | |
|---|---|---|---|---|---|---|
| | FOAM | THICKNESS, | DENSITY, PCF | ADHESION, | | PSA |
| EXAMPLE | SHEET? | mil (mm) | (g/cm³) | g/in (g/cm) | | SHEET? |
| Comparative | no | 36.9 (0.94) | 67.64 (1.08) | 53.8 | (21.18) | no |
| Example A | | | | | | |
| 1 | yes | 46.7 (1.19) | 62.91 (1.01) | 163.2 | (64.25) | yes |
| 2 | yes | 61.3 (1.56) | 50.27 (0.81) | 23.1 | (9.09) | yes |
| 3 | yes | 58.8 (1.49) | 51.84 (0.83) | 7.84 | (3.09) | yes |
| 4 | yes | 56.6 (1.44) | 47.76 (0.77) | 11.43 | (4.50) | yes |
| 5 | yes | 54.2 (1.38) | 48.80 (0.78) | 16.6 | (6.54) | yes |
| 6 | yes | 51.6 (1.31) | 55.20 (0.88) | | | no |
| 7 | yes | 55.9 (1.42) | 55.03 (0.88) | | | no |
| 8 | yes | 64.1 (1.63) | 50.26 (0.81) | | | no |
| 9 | yes | 53.2 (1.35) | 59.34 (0.95) | | | no |
| 10 | yes | 59.3 (1.51) | 46.45 (0.74) | | | no |
| 11 | yes | 58.2 (1.48) | 51.28 (0.82) | | | no |
| 12 | yes | 60.9 (1.55) | 49.21 (0.79) | | | no |
| 13 | yes | 46.9 (1.19) | 56.52 (0.91) | | | no |
| 14 | yes | 56.0 (1.42) | 48.16 (0.77) | | | no |
| 15 | yes | 26.8 (0.68) | 55.10 (0.88) | 4.1 | (1.61) | no |
| 16 | yes | | | | | yes |
| 17 | yes | | | | | yes |
| 18 | yes | | | | | no |
| 19 | yes | | | | | no |
| 20 | yes | | | | | no |
| 21 | yes | | | | | no |
| 22 | yes | | | | | no |
| 23 | yes | | | | | no |
| 24 | yes | | | | | no |

The preceding description, given in order to enable one of ordinary skill in the art to practice the claimed disclosure, is not to be construed as limiting the scope of the disclosure, which is defined by the claims and all equivalents thereto.

1. A method of making a crosslinked silicone foam, the method comprising:
disposing a crosslinkable composition on a first substrate, wherein the crosslinkable composition comprises components:
(i) at least one first poly(organosiloxane) having a plurality of Si—H groups, and
(ii) at least one second poly(organosiloxane) having a plurality of Si—OH groups; and
exposing the crosslinkable composition to high energy radiation in an amount effective to form a crosslinked poly(organosiloxane) foam disposed on the first substrate.

2. The method of claim 1, wherein:
the at least one first poly(organosiloxane) is represented by the formula 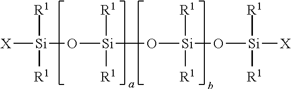
wherein
each R¹ independently represents an alkyl group having from 1 to 18 carbon atoms or phenyl,
each X independently represents H or R¹,
a represents an integer greater than or equal to 0, and
b represents an integer greater than or equal to 2,
with the proviso that if a is 0 then both X are H, if only one X is H then a is at least 1, and if neither X is H then a is at least 2; and
the at least one second poly(organosiloxane) is represented by the formula 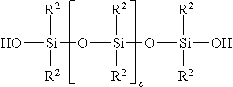
wherein
each R² independently represents a hydrocarbyl group having from 1 to 18 carbon atoms and
c represents an integer greater than or equal to 2.

3. The method of claim 1 , wherein the crosslinked poly(organosiloxane) foam is free of hollow microspheres.

4. The method of claim 1, wherein the crosslinked poly(organosiloxane) foam has a porosity of at least 10 volume percent.

5. (canceled)

6. The method of claim 1, wherein the crosslinkable composition further comprises at least one MQ silicone tackifying resin.

7. The method of claim 1, wherein the crosslinkable composition is exposed to electron beam radiation.

8. The method of claim 1, wherein the crosslinked poly(organosiloxane) foam is a pressure-sensitive adhesive at 20 degrees Celsius.

9. The method of claim 1, wherein the crosslinkable composition is free of catalysts for reaction of component (i) with component (ii).

10. The method of claim 1, further comprising sandwiching the crosslinkable composition between the first substrate and a second substrate prior to exposing the crosslinkable composition to the high energy radiation.

11. The method of claim 1, wherein the first substrate comprises a first releasable liner.

12. The method of claim 11, further comprising separating the crosslinked poly(organosiloxane) foam from the first substrate.

13. The method of claim 11, wherein the second substrate comprises a second releasable liner.

14. The method of claim 13, further comprising separating the crosslinked poly(organosiloxane) foam from the second substrate.

15. A crosslinked poly(organosiloxane) foam prepared by the method of claim 12.

16. A crosslinked poly(organosiloxane) foam comprising Si—H groups and Si—OH groups wherein the crosslinked poly(organosiloxane) foam is free of an effective amount of organic peroxide and an effective amount of dehydrogenative coupling catalyst for the reaction of the Si—H groups with the Si—OH groups.

17. The crosslinked poly(organosiloxane) foam of claim 16, wherein the crosslinked poly(organosiloxane) foam is free of hollow microspheres.

18. The crosslinked poly(organosiloxane) foam of claim 16, wherein the crosslinked poly(organosiloxane) foam has a porosity of at least 10 volume percent.

19. (canceled)

20. The crosslinked poly(organosiloxane) foam of claim 16, wherein the crosslinked poly(organosiloxane) foam is a pressure-sensitive adhesive at 20 degrees Celsius.

21. The crosslinked poly(organosiloxane) foam of claim 20, wherein the crosslinked poly(organosiloxane) foam further comprises at least one MQ silicone tackifying resin.

22. An article comprising:
the crosslinked poly(organosiloxane) foam of claim 16 sandwiched between a first substrate and a second substrate, wherein the first substrate is releasably adhered to the crosslinked poly(organosiloxane) foam.

23.-24. (canceled)
